(19) United States
(12) Patent Application Publication
(10) Pub. No.: US 2003/0173423 A1
(43) Pub. Date: Sep. 18, 2003

(54) Water tool

(76) Inventors: Hans-Christoph Haenlein, Cupertino, CA (US); Robert Peter Arko, Palo Alto, CA (US); Nancy J. Serpiello, San Carlos, CA (US); Karen Tsuei, Redwood City, CA (US)

Correspondence Address: Kwadjo Adusei-Poku, Masco Corporation, 21001 Van Born Road, Taylor, MI, 48180, US

(21) Appl. No.: 10/360,940

(22) Filed: Feb. 6, 2003

Related U.S. Application Data
(60) Provisional application No. 60/354,709, filed on Feb. 6, 2002.

(51) Int. Cl. B05B 7/02

(52) U.S. Cl. 239/526

(57) ABSTRACT

A water tool having a jet spray mode of operation comprising a spray body, a spray spout connected to and extending from the spray body, an activating mechanism attached to the spray body, a valve mechanism in communication with the activating mechanism, and a spray nozzle having an aerated flow mode and a jet flow mode, such that as the activating mechanism is employed, the valve mechanism serves to divert the flow of water through the spray nozzle in either the aerated flow mode or the jet spray mode.

### RELATED APPLICATIONS

This application claims priority from U.S. Provisional Application No. 60/354,709 filed Feb. 6, 2002.

### THE FIELD OF THE INVENTION

The present invention relates to a water tool for a faucet that may provide a high velocity water spray at moderate water flow rates. This water tool, according to the invention, may be used with a side spray of the type commonly used with a kitchen faucet, or with the faucet head, preferably with a pullout faucet head.

### BACKGROUND OF THE INVENTION

There is often a need for a faucet to be able to clean around the edges of the sink or bathtub. This has been accomplished by, among other ways, providing a separate side spray that could be employed and manipulated around the edges of the sink. An improvement to the side spray employed a pullout spout for the faucet, in which the faucet head may be deployed from the faucet base and moved around the sink, thereby directing the water flow directly towards any debris within the sink.

There remains, however, a need to provide a device that enhances either the pullout spout or the side spray to provide a water tool that directs a powerful water spray towards any debris in the sink or tub. For, although both the side spray and the pullout faucet methods provide a means for directing the water flow around the sink in order to clean the sink, the water pressure is often too weak to effectively remove any debris from the sink. The operator is typically required to wash the sink manually, and use the water flow for rinsing purposes only.

The present invention provides a water tool that is capable of using the lower flow rates of water available at the faucet or at the side spray and converting this faucet or side spray into a powerful, directed water spray. This is accomplished by providing a setting, selectable by the user, which restricts and shapes the nozzle cross sectional area.

### SUMMARY OF THE INVENTION

To enable an increase of stream force by restricting the flow through a small diameter nozzle, and in this way does the same or a better job at food debris removal than would otherwise be achieved by simply increasing the flow rate.

An additional valve position at the wand head would divert water through a “Water Tool” nozzle. We would then have three possible water configurations: Aerated Column, Distributed Spray and Water Tool.

In a preferred embodiment, the invention employs a standard high-pressure water cleaner nozzle having a flat-water fan with a 25° fan angle. Although this appears to be the preferred geometry for such a water tool, fan angles between 10 degrees and 45 degrees are also envisioned.

It is also envisioned as part of the invention, that a proportional valve may be used to provide a progressively increasing jet spray, corresponding to the level of pressure put on the selector device.

### BRIEF DESCRIPTION OF THE DRAWINGS

FIG. 1 is a perspective view of the water tool of the present invention as part of a pullout spout of a faucet;

FIG. 2 is a perspective view of the water tool of the present invention as part of either a pullout spout of a faucet or as part of a side spray;

FIGS. 3 and 4 illustrate the water spray patterns from a faucet as readily present in the prior art, showing the steady flow and aerated flow patterns, respectively;

FIGS. 5-7 illustrate the water spray patterns from a faucet incorporating the water tool of the instant invention, showing the steady flow, the aerated flow, and the water jet patterns, respectively;

FIGS. 8-10 illustrate the three-position side spray actuator mechanism of the instant invention;

FIG. 11 is an exploded view of the side spray showing the actuator mechanism, and illustrating the water tool nozzle;

FIG. 12 is a partial cutaway of the side spray showing the water tool nozzle installed on the side spray and showing the rocker actuating mechanism;

FIG. 13 is an elevational cross-sectional view of the side spray incorporating the instant invention;

FIG. 14 is a perspective view of the side spray having the water tool nozzle attached;

FIG. 15 is a top perspective view of the water tool nozzle according to the instant invention;

FIG. 16 is a side elevational view of the water tool nozzle;

FIG. 17 is a top plan view of the water tool nozzle;

FIG. 18 is a cross-sectional view of the water tool nozzle; and

FIG. 19 is an exploded view of the water tool nozzle and the aerator nozzle as assembled within the side spray.

### DESCRIPTION OF THE PREFERRED EMBODIMENT

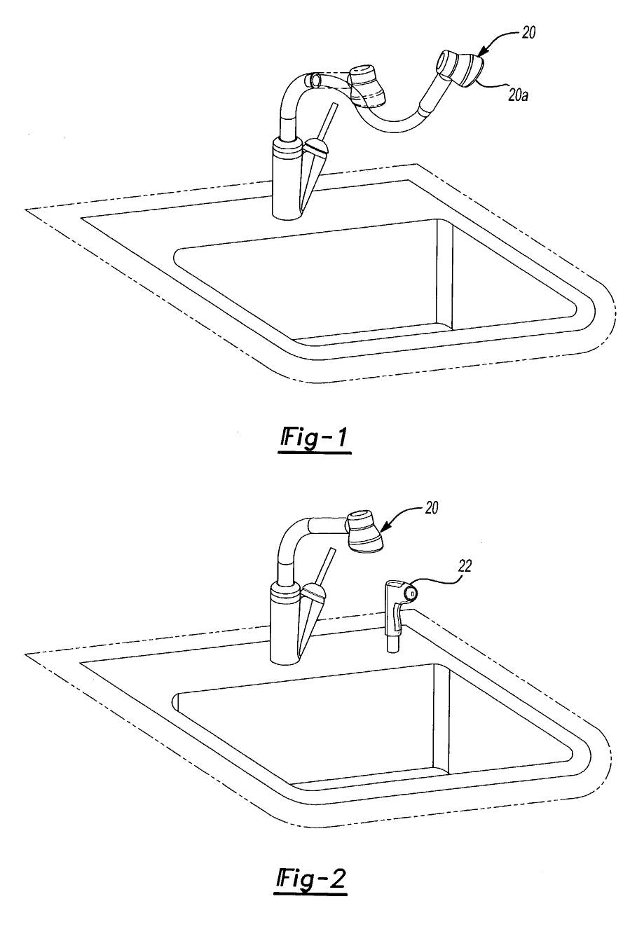

FIGS. 1 and 2 illustrate the water tool 20 of the instant invention. FIG. 1 shows the water tool 20 as part of a pullout spout 20a of a faucet. For example, the water tool 20 may be attached using the current Delta configuration for its Delta 470 pullout kitchen faucet.

FIG. 2 illustrates the water tool 20 as used in both the pullout configuration and as a side spray 22. When used as part of the side spray 22 configuration, the invention employs a diverter valve similar to the one described in U.S. Pat. No. 4,927,115 (the '115 patent), incorporated in its entirety herein. It is also envisioned that the diverter valve described in U.S. Pat. No. 5,014,919 (the '919 patent”) for a “Small Hand-Held Shower Head for Domestic Sinks Connected to a Faucet,” also incorporated in its entirety by reference herein. When the side spray is in use, this diverter valve is meant to shut off water flow to the spout and direct it to the side spray. In order for it to work properly and to shut off the water flow to the spout completely, there needs to be an adequate pressure drop across it when the side spray is in use. A small nozzle orifice for the water tool 22 will give an efficient, low flow rate/high velocity, water jet, but will also lead to a high back pressure which will in turn provide for a low pressure drop across the diverter valve. A larger nozzle orifice will provide a higher-pressure drop for the diverter valve, but may lead to a water tool 22 with very little water pressure when in the jet spray mode.

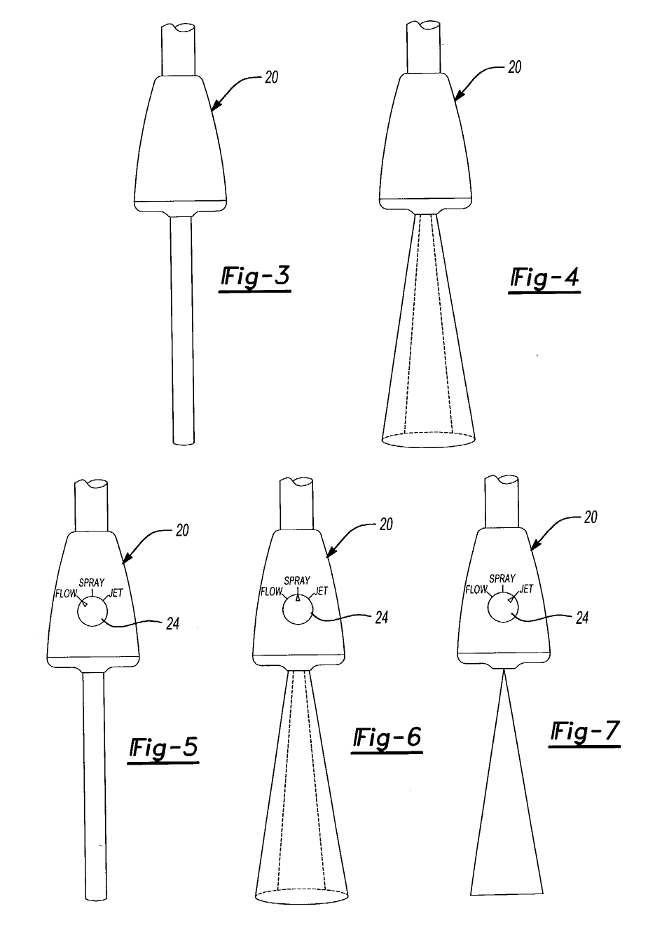

Referring to FIGS. 3-7, the water tool 20 spray pattern is illustrated. Referring to FIG. 3, an ordinary aerated flow pattern is shown. FIG. 4 illustrates one particular spray pattern. As now shown in FIGS. 5-7, the water tool 20, may have a diverter dial 24, with a number of different spray pattern positions indicated. Although the diverter dial 24 shown in FIGS. 5-7 shows a three-position setting, corresponding to a three-way diverter valve, numerous other settings may be employed. Referring to FIGS. 5-7, the dial 24 may be moved between the flow position (FIG. 5) to a spray position (FIG. 6) to the jet position (FIG. 7).

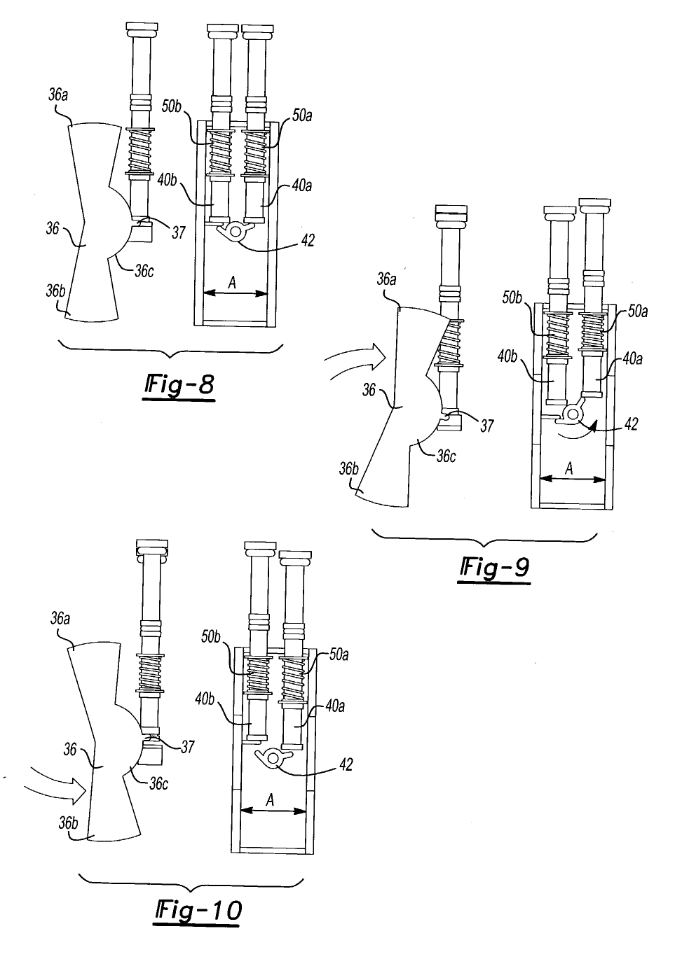

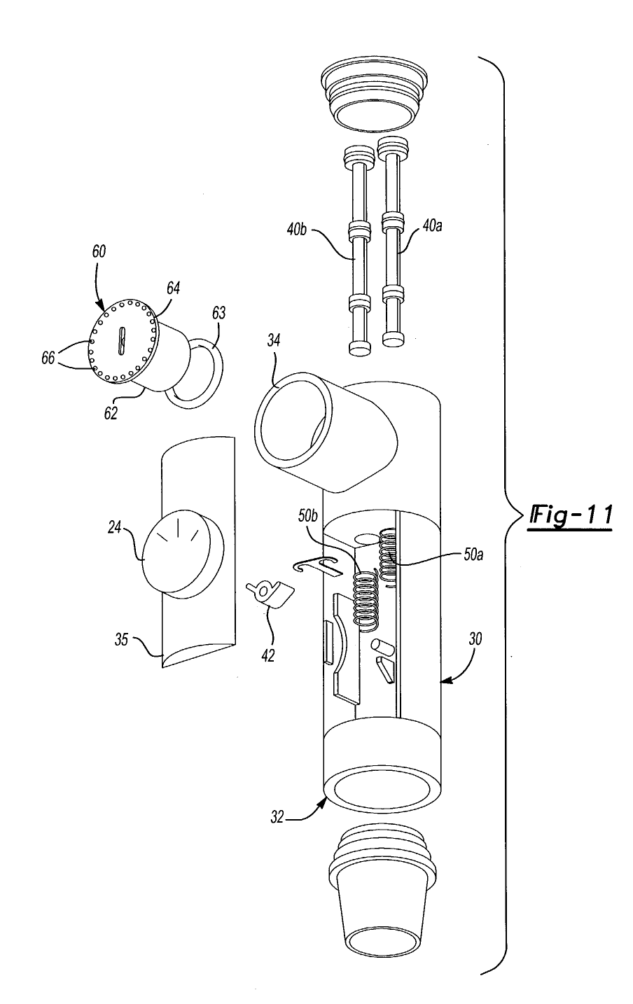

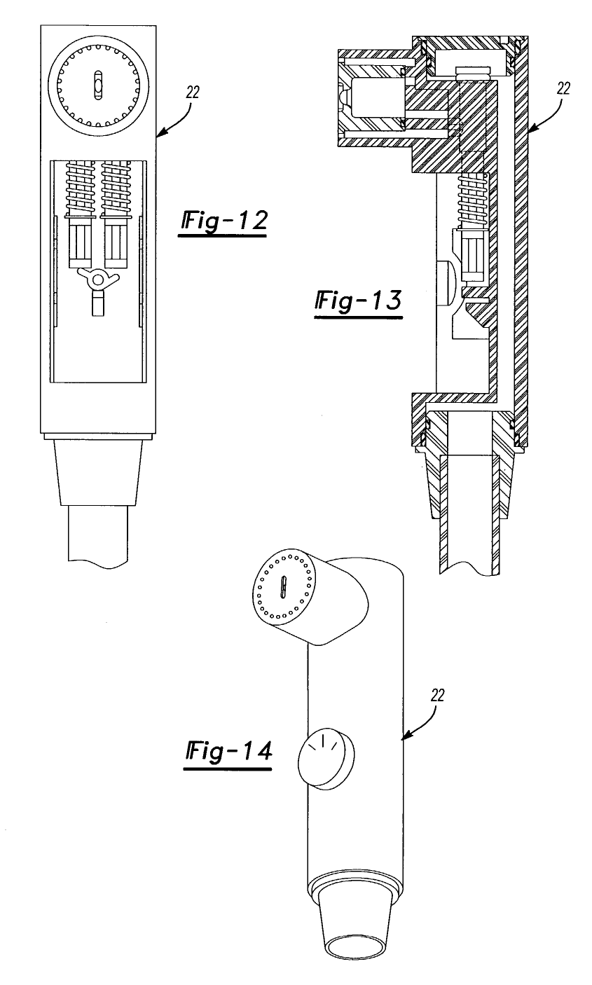

Referring to FIGS. 8 through 14, the water tool 22 comprises a spray body 30 having a connecting end 32, and a spray spout 34. Also attached thereto is a trigger or activating mechanism 36 that may either employ a diverter dial 24 as shown in FIG. 11, or simply comprise a trigger 36, as shown in FIGS. 8-10. A cover 38 is placed on top of the spray body 30.

Incorporated within the spray body 30 is a valve mechanism. FIGS. 8-13 illustrate one such valve mechanism that may be employed with the invention. However, as is immediately evident to someone skilled in the art, numerous valve mechanisms would work equally well with the water tool invention. As shown in FIGS. 8-10, the valve mechanism employs two valve components 40a and 40b, a bell crank component 42, and springs 50, placed about the valve components 40a and 40b. As shown in FIG. 8, the trigger 36 has a upper end 36a and a lower end 36b, and circular rocker portion 36c. Extending outwards from the rocker actuator 36c is a tab 37. FIG. 8 shows trigger 36 in the neutral or off position. As the upper end 36a is depressed by an operator, the tab 37 displaces the bell crank component 42, thereby causing one of the valves 40a to move upwards away from the valve seat into an open position. This causes water to be diverted through the valve 40a, resulting in one particular spray pattern. As the trigger 36 is released, the spring 50a returns the valve 40a to its resting position as shown in FIG. 8. Now, referring to FIG. 9, as the lower upper end 36b is depressed by an operator, the tab 37 displaces the bell crank component 42, thereby causing the other of the valves 40b to move upwards away from the valve seat into an open position. This causes water to be diverted through the valve 40b, resulting in a different spray pattern. As the trigger 36 is released, the spring 50b returns the valve 40b to its resting position as shown in FIG. 8.

By employing a single rocker actuator 36c using trigger 36, the water tool 22 is limited to a two position tool, from either the aerated flow mode, the water tool mode, or the OFF position. Thus, the first position, with valve 40a in the open position may correspond to the aerated flow mode, and the second position, with the valve 40b in the open position may correspond to the water tool or jet spray mode.

Although the trigger 36 may be configured in any desirable way, the preferred embodiment employs the upper end 36a of the trigger 36 as the main, most easily employed position, and assigns the normal aerated flow mode to this position. This primary aerated flow mode is most naturally activated by squeezing the trigger 36 with the forefinger. The lower actuator position, therefore, corresponds to the water tool or jet spray mode, and is more readily squeezed with the middle and ring finger together.

To ensure an adequate and comfortable grip on the trigger 36, the trigger length is preferably between 2½ inches and three inches.

Also, according to the invention, the pivot axis of the trigger 36 does not need to pass through the center of the trigger 36. There may be some benefit in having the lower end 36b be slightly longer than the upper end 36a. This would tend to decrease the effort needed to lift the valves 40a and 40b, and may also give a slightly finer control of the flow rate.

As shown in FIGS. 8-10, the width A of the spray body 30 depends upon the diameter of the valves 40a and 40b, and the diameter of the springs 50a and 50b. Although it is possible to use slightly smaller diameter valves, limiting factors include ensuring adequate flow when the valves are open. Also, to ensure a stiff enough component for the trigger 36 and bell crank 42 to push against, the springs 50a and 50b must be of a certain spring stiffness. An advantage to using smaller valves would be a lowering of the force exerted by water pressure on their top faces, and a corresponding lowering of the spring rate and actuation effort.

FIG. 11 shows an exploded view of another embodiment of the invention. In FIGS. 11 through 14, a front plate 35 is employed in place of trigger 36. The diverter dial 24 is positioned on this front plate 35, and provides the operator a method for selecting between the different spray modes. Similar to the operation described above, rotating the diverter dial 24 displaces the bell crank 42 to move the valves 40a and 40b into the open positions respectively.

Referring to FIGS. 11 through 14, the spray nozzle 60 comprises a body 62 and a faceplate 64. The faceplate 64 is preferably circular and has positioned around its circumference a plurality of aerator holes 66. In the center of the faceplate 64 is positioned an elongated aperture 68. As water or other fluid passes through the spray nozzle 60, the water may be diverted through either the aerator holes 66, resulting in the aerated flow pattern, or else, directed through the elongated aperture 68, resulting in the jet flow.

From direct experiments with a modified side spray attached to a Delta 480 side spray Faucet, an elongated aperture 68 having a length of between 0.1″ and 0.060″ was preferred, giving a sufficient pressure drop for the diverter valve to work in its preferred mode, and still provided a useful jet of water in the jet spray mode. This diameter represents a cross sectional area of 0.078 square inches. However, it is also possible to employ an elongated aperture 68 of a length limited only by the diameter of the faceplate 64.

The effectiveness of the water tool 22 with a given elongated aperture dimension did not seem to be very dependent on the water pressure, until the water pressure was lowered to approximately 10 psi. However, it should be observed that most experiments were conducted at line water pressures of approximately 40 psi.

Flat Fan Nozzle Geometry

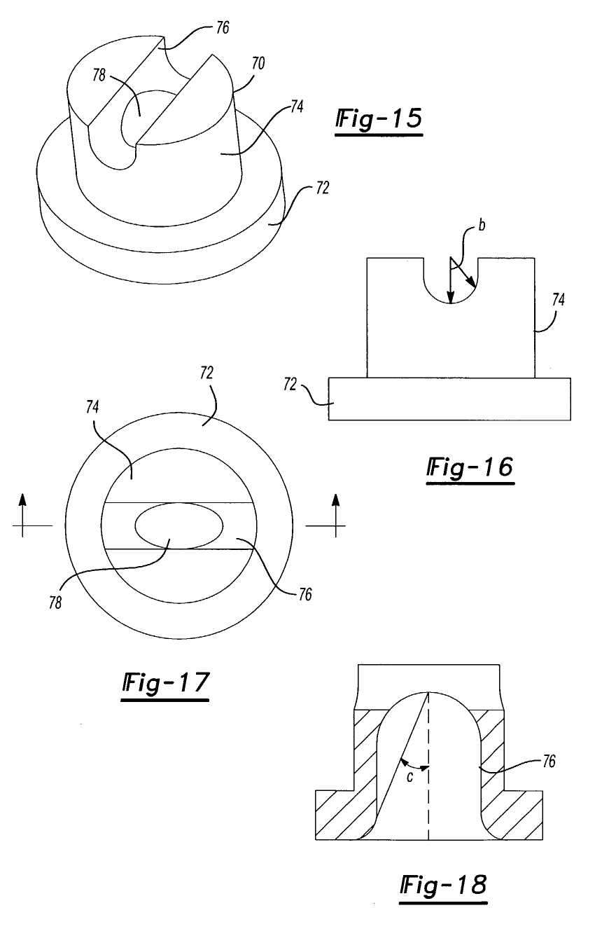

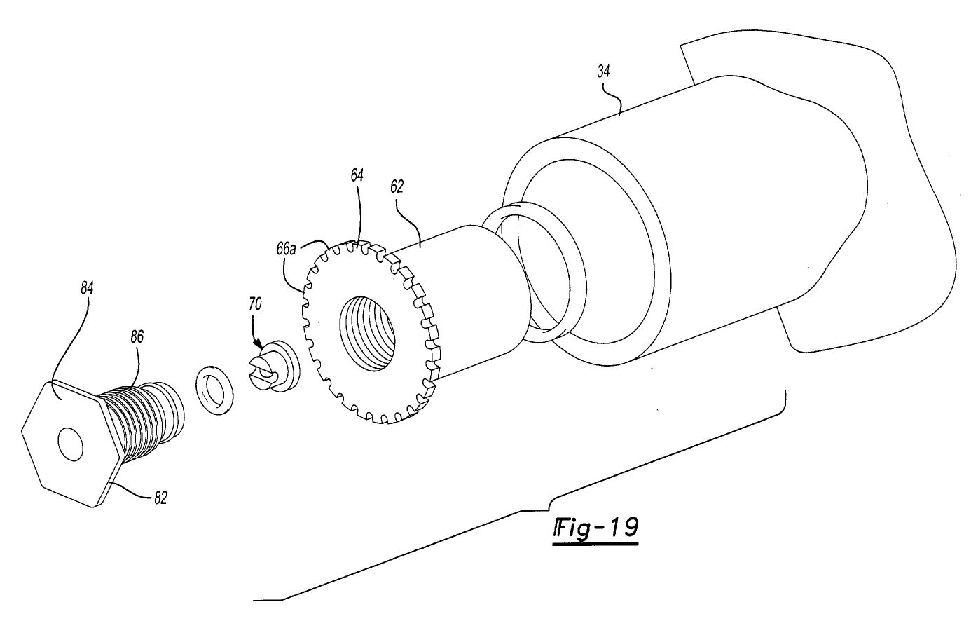

As illustrated in FIGS. 15 through 18, abutting the elongated aperture 68, and concurrent with the elongated aperture 68 is a fan nozzle 70. The fan nozzle 70 comprises a circular base portion 72, a cylindrical body portion 74 having a top surface 75, an elongated groove 76 positioned across the top surface 75, and a fluid passageway 78 located within the groove 76.

In a preferred embodiment of the invention, employing a flat fan shape maximized the spray pattern for the water tool. The elongated aperture 68, as defined by the dimensions of the groove 76, was modified to give a fan angle of 25 degrees. In order to arrive at a suitable geometry for the side spray, the geometry of this component needed to be digitized and scaled to give us the correct nozzle cross sectional area. In addition, the sensitivity to small changes in nozzle geometry needed to be understood so that the geometry could be correctly dialed in and toleranced. After experimentation, the preferred dimensions for the elongated aperture 68 had a cross-sectional area of 0.075 square inches. This resulted in a flat fan of 23 degrees. It was also observed that there is an approximate relationship between the of fan angle and the depth b of the groove 76; for a given groove width c, the shallower the groove 76 and the narrower the fan angle. Extrapolating from this data, fan angles of between 10 and 15 degrees would be generated using values for the groove radius offset r from 0.017″ down to 0.05″.

As shown in FIG. 19, the water tool 20 spray nozzle 60 may be combined as a single jet nozzle component 80. As illustrated, the jet nozzle 80 comprises an angular insert 82, the jet nozzle 70, and the nozzle body 62. The angular insert 82 comprises an angular face portion 84 and a cylindrical threaded body portion 86. As shown, the angular insert 82 screws into the central aperture 88 of the nozzle body 62. The single jet nozzle 80 is inserted within the spray spout 34. In order to ensure that the elongated groove 76 of the fan nozzle 70 is properly aligned, a positive stop may be employed. Also, instead of using aerator holes 66, a plurality of notches 66a may be carved out of the faceplate 64, thereby creating a similar aerated effect.

Directional Spray Control

The decoupled water tool valve block was prototyped to validate the water tool concept in the context of the pullout assembly. These prototypes contain a valve block upstream of the current pullout selector valve, with outlet ports to a water tool nozzle and the selector valve, and a push-button shuttle to select the water tool. The shuttle is designed to be momentary and proportional to give the desired user behavior. The push-button shuttle represents a mechanism for activating the water tool, and may be incorporated into a trigger configuration at the user interface.

It is also envisioned within the scope of the invention to use the water tool 20 on a pullout faucet. This would enable a user to provide a high velocity water jet directed at a point within the sink to remove debris if so desired. The water tool in effect provides a mechanism whereby the water stream force is increased by restricting the flow through a small diameter nozzle. In effect, the user may now remove food and other debris more efficiently than could be achieved by simply increasing the water flow rate.

As with the side spray, an additional valve position at the wand head would divert water through the water tool nozzle, resulting in three possible water configurations, (1) aerated column, (2) distributed spray, and (3) the water tool jet spray pattern.

As described above, the preferred nozzle pattern resulted in a flat water fan with a 25° fan angle.

A proportional valve would give us a progressively harder tool for a progressively harder push on the selector device.

In a preferred embodiment of the invention, one of a number of actuator configurations may be employed. For example, a sliding actuator interface could be provided with the additional feature of having a third position that employs the water tool option.

It is further anticipated that the water tool could either be latched or momentary. For the momentary alternative, the trigger 36 or actuator 37 would be spring-loaded and would return to either the off position or to one of the other flow states after the actuator is deployed. Further, the water tool or jet spray mode could also be either fixed rate or proportional. In the proportional embodiment, the force of the water would be proportional to the amount the user depressed the actuator.

These High flow rates through such a small nozzle will create an excessively powerful jet of water. Accordingly, a mechanism is also envisioned whereby the water flow is restricted in order to obtain the required or optimal force.

Valve Operation:

The main valve block is a machined manifold, which contains an inlet port, and two outlet ports connected by a shuttle chamber 100. A hollow shuttle connecting the inlet to the outlets is sealed by o-rings so that only one of the outlet paths is connected to the inlet at any time. This is similar in concept to the current pullout selector valve shuttle. The shuttle orifice leading to the water tool is shaped to provide proportional flow depending on the amount the shuttle is depressed.

The shuttle is spring loaded to return to the OFF position, and designed so that water pressure is balanced around the part. The user must press against only the spring force in order to switch the flow to the water tool.

Momentary High Water Pressure

The current design for the water tool valve block allows a position in which neither valve path is open. Although the shuttle does not rest in this position, it may be held there by hand. At this position, full line pressure will develop upstream of the water tool valve block, in other words, throughout the entire main valve assembly and all the connected flexible hoses. A possible solution of issue is to have the water tool and spray head functions overlap. Functionally, this will have a negligible effect on the water tool 20 performance.

Flow Regulation and Continuous High Water Pressure

Since the water tool 20 will create a high velocity at even moderate flow rates, a flow regulator may be required to set a maximum that avoids spray and splash from the water tool's jet. This flow restriction will probably cause significant backpressure upstream. Although this is probably less than full line pressure, it may be above the pressure normally associated with the upstream components.

While the invention has been described in what is considered to be a preferred embodiment, other variations and modifications will become apparent to those skilled in the art. It is intended, therefore, that the invention not be limited to the illustrative embodiment but be interpreted within the full spirit and scope of the appended claims.

I claim:

1. A water tool having a jet spray mode of operation comprising:
a spray body,
a spray spout connected to and extending from the spray body,
an activating mechanism attached to the spray body,
a valve mechanism in communication with the activating mechanism, and
a spray nozzle having an aerated flow mode and a jet flow mode,
such that as the activating mechanism is employed, the valve mechanism serves to divert the flow of water through the spray nozzle in either the aerated flow mode or the jet flow mode.

2. The water tool according to claim 1, wherein the activating mechanism is a trigger mechanism that may be moved between a first activated position, to a neutral position, to a second activated position.

3. The water tool according to claim 1, wherein the activating mechanism is a diverter dial connected to a three-position diverter valve, such that a user may select between a first aerated flow, a second laminar flow, and a third jet spray position.

4. The water tool according to claim 2, further comprising a cover plate on top of the spray body.

5. The water tool according to claim 4, wherein the trigger mechanism has an upper arm and a lower arm, and wherein the upper arm is shorter than the lower arm.

6. The water tool according to claim 5, wherein the lower arm of the trigger mechanism is between 21/2 and 3 inches.

7. The water tool according to claim 2, wherein the spray nozzle comprises:
a body,
a faceplate, the faceplate being circular,
a plurality of aerator holes position around the circumference of the face plate, and
an elongated aperture positioned within the faceplate.

8. The water tool according to claim 7, wherein the elongated aperture is between 0.1 inches and 0.06 inches.

9. The water tool according to claim 8, wherein the elongated aperture has a cross sectional area of 0.078 square inches.
